(19) United States
(12) Patent Application Publication
(10) Pub. No.: US 2003/0018773 A1
(43) Pub. Date: Jan. 23, 2003

(54) Method and apparatus for transmitting information

(76) Inventors: Mark Beckmann, Braunschweig (DE); Martin Hans, Hildesheim (DE); Michael Eckert, Braunschweig (DE); Andreas Otte, Celle (DE)

Correspondence Address: Bell, Boyd & Lloyd LLC, P.O. Box 1135, Chicago, IL, 60690, US

(21) Appl. No.: 10/141,433

(22) Filed: May 7, 2002

(30) Foreign Application Priority Data
May 7, 2001 (DE) 101 22 079.0
Oct. 11, 2001 (DE) 101 50 106.4

(51) Int. Cl. G06F 15/173

(52) U.S. Cl. 709/223

(57) ABSTRACT

A method, an apparatus and a communication system in which the amount of data to be processed is reduced while offering a higher level of flexibility and better availability for a provider or operator of a communication system, wherein the user is allocated to at least one group of users as an access and/or usage precondition for the communication system, with the same information being transmitted to all the users in a group.

### BACKGROUND OF THE INVENTION

The present invention relates to a method for transmitting information, to a corresponding apparatus and to a communication system. The present invention furthermore relates, in particular, to a region in which information is transmitted in electronic form from a provider to a registered user or subscriber in a communication system.

For the purposes of the present invention, the term information essentially covers not only any form of message but also advertising information or unsolicited information; that is to say, in particular, an offer, an advertising announcement or advertisement for a new product, and consumer information in some other form.

In many services and applications which are offered in known modem communication systems, information is intended to be transmitted not just to one mobile radio subscriber but to two or more mobile radio subscribers. Examples of services and applications such as these include news groups in the Internet, video conferences, video-on-demand, distributed applications and many more. When transmitting messages to the various subscribers, it is possible to send a copy of the data separately to each recipient. Although this technique can be implemented easily using so-called unicast connections, it is unsuitable for large groups. Because the same message is transmitted via N individual connections when being sent to N recipients and, in the process, is sent several times via the same connecting routes, this method requires a very wide bandwidth.

The present invention is therefore, directed toward a method, an apparatus and a communication system in which the amount of data to be processed is reduced, while providing a higher level of flexibility and better availability for a provider or operator of a communication system.

### SUMMARY OF THE INVENTION

A method according to the present invention is accordingly distinguished in that the user is allocated to at least one group of users as an access and/or usage precondition for the communication system, with the same information being transmitted to all the users in one group. Accordingly, an apparatus according to the present invention has a device which is addressed by the provider or operator of the communication system via an address for transmitting information, and which sends this information automatically to all the subscribers who are known or registered in the device. The provider or operator of the communication system thus sends each item of information only once, with the specific distribution being carried out by the device. The load on the common connecting routes is thus, greatly reduced, and capacities are available to the provider in order to send further information to additional devices with respectively associated subscribers.

Further embodiments of the present invention propose that users in a target and/or interest group are combined to form one group with, in one development, a regional group being allocated a broadcast address. In this case, each user is associated with at least one such address as an access precondition. In one preferred embodiment of the present invention, the user is accessed via a mobile station as an interface to the communication system.

The information is preferably transmitted via the communication system to a mobile station in the form of a mobile telephone using a known mobile radio standard; in particular, being transmitted by the provider to the user using the UMTS Standard, at least in places. As will also be explained in the following text with reference to exemplary embodiments, the data for group allocation and a message and information reference between an operator and user may have different forms.

Alternatively or in addition, a group may be formed by creating regional boundaries. It is likewise possible to transmit information as a multicast message.

The transmission of information is preferably initiated by registration of the user with the communication system; in particular, by switching on a subscriber terminal.

In one embodiment of the present invention, a device can also transmit acknowledgements to the provider; in particular, in order to evaluate a load level at any given time and/or for billing. However, usage data and/or other data also can be evaluated for one respective user, so that the user is on this basis allocated to one or more groups for specific information supply, with his/her specific communication behavior being evaluated, particularly in the form of automatic tariff allocation. As such, a usage charge for a specific user can, for example, be established as a function of the nature and/or number of groups in which the user is registered to receive information. Termination of the association with a group can be equated to a tariff increase for further use of a communication system according to the present invention, while notification from the last group as well can be equated to complete termination of use, with this user being excluded from the communication system in the future.

Reference should be made to the following description of exemplary embodiments for specific refinements and advantageous uses.

In order to allow the possible data rate of a mobile radio connection to be increased while the bandwidth which is being used remains constant, it is also possible to use communication systems with new network structures, in addition to new modulation methods. In a communication system according to the present invention, a unit with a group address is provided in order to carry out information distribution and administration tasks on a specific basis. A major field of application for embodiments of the present invention thus can be seen in a mobile radio system using the UMTS Standard (Universal Mobile Telecommunication System). In one embodiment of the present invention, advertising banners or logos, for example, are displayed on the recipient's screen or display via multicast transmission while the mobile radio is being used. A further option is to interrupt the visual or audible transmission for a specific time, in which information from the advertiser is then transmitted via multicast. As a trade-off, the mobile radio subscriber is, according to the present invention, provided with a cheaper monthly basic price, lower prices per minute, free minutes or other benefits. These benefits are then subsidized by the advertising company. One advantage of this embodiment according to the present invention is that mobile radio subscribers can be provided with advantageous conditions for use of a mobile radio system, provided they state that they are prepared to allow certain messages to be displayed on their mobile radio. For the operator of the mobile radio system, a system according to the present invention advantageously offers a further source of income, resulting from the transmission of advertising contents. It is also particularly advantageous that companies and other advertisers have the capability, according to the present invention, to make their product information available to a wide public, with direct customer access and, in particular, with a very short time delay and at little cost. Since the information exists only in electronic form, this avoids all other forms of physical production, such as printing. In addition to saving production costs and conservation of resources, this results in a considerable speed advantage.

One major feature of the method according to the present invention is that an operator of a communication system, or provider, organizes membership, association or registration in a group of recipients of specific information, for each user or subscriber. According to the present invention, the subscribers state that they are prepared to allow the operator to enter them in at least one specific group, and are then prepared to receive the messages for the appropriate groups. This registration is an access and/or usage precondition for each user in the communication system, with the same information being transmitted to all the users in one group. This system is made more attractive by usage charges being subsidized on an advantageously graduated basis, in which case even toll-free use is possible.

Additional features and advantages of the present invention are described in, and will be apparent from, the following Detailed Description of the Invention and the Figures.

### BRIEF DESCRIPTION OF THE INVENTION

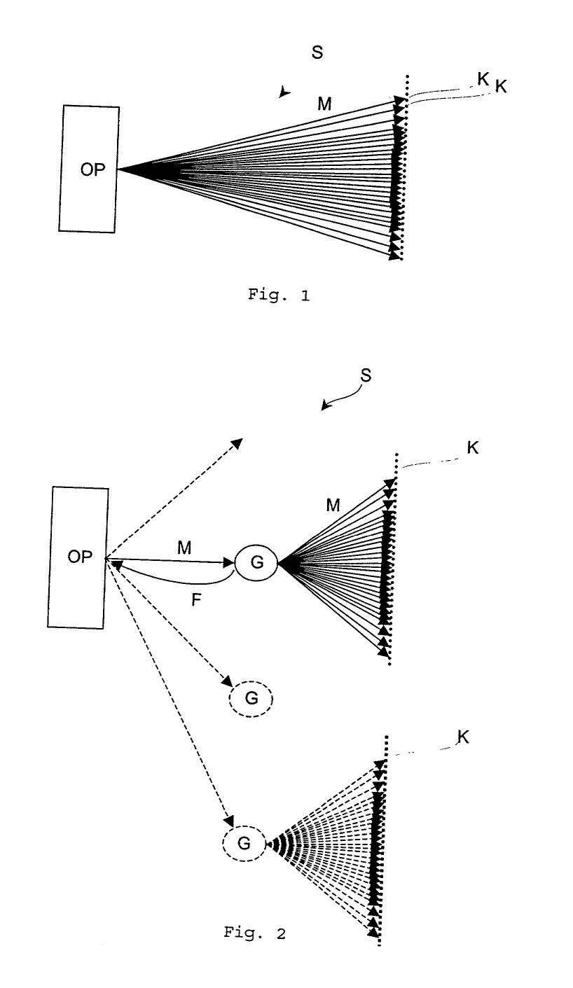

FIG. 1 shows a simplified block diagram relating to the implementation of a known structure for information transmission.

FIG. 2 shows a simplified block diagram of a basic principle of one embodiment according to the present invention.

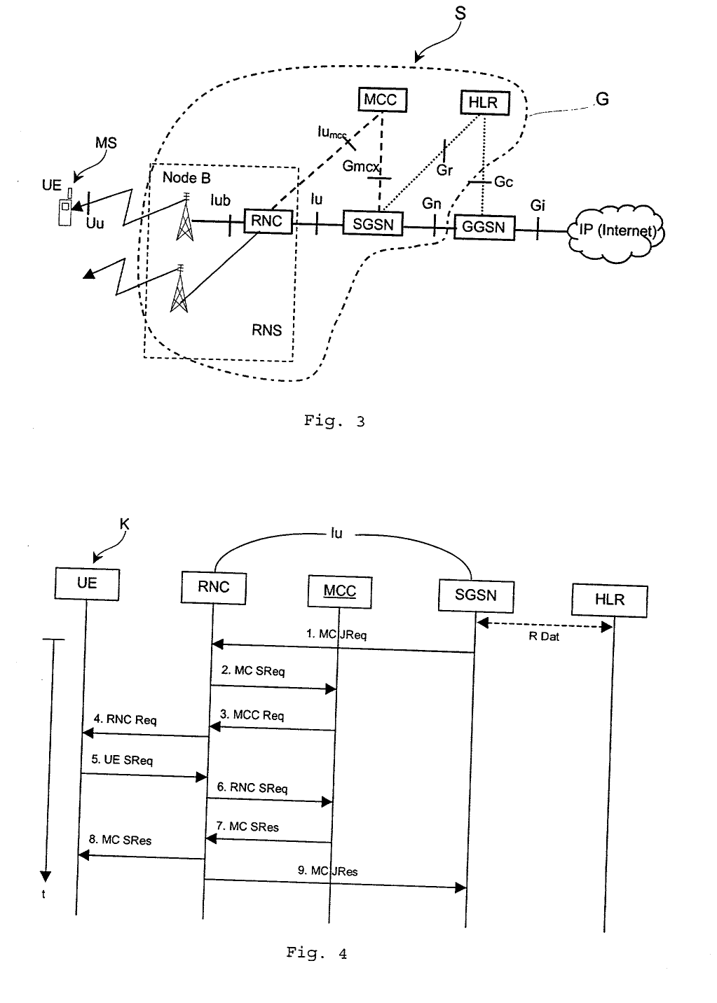

FIG. 3 shows block diagram of one embodiment of the present invention, integrated into a mobile radio system based on the UMTS Standard.

FIG. 4 shows a diagram to illustrate the waveform of individual signals plotted against time, for a further embodiment of the present invention.

FIG. 5 shows a diagram, corresponding to the illustration in FIG. 4, for a further embodiment of the present invention.

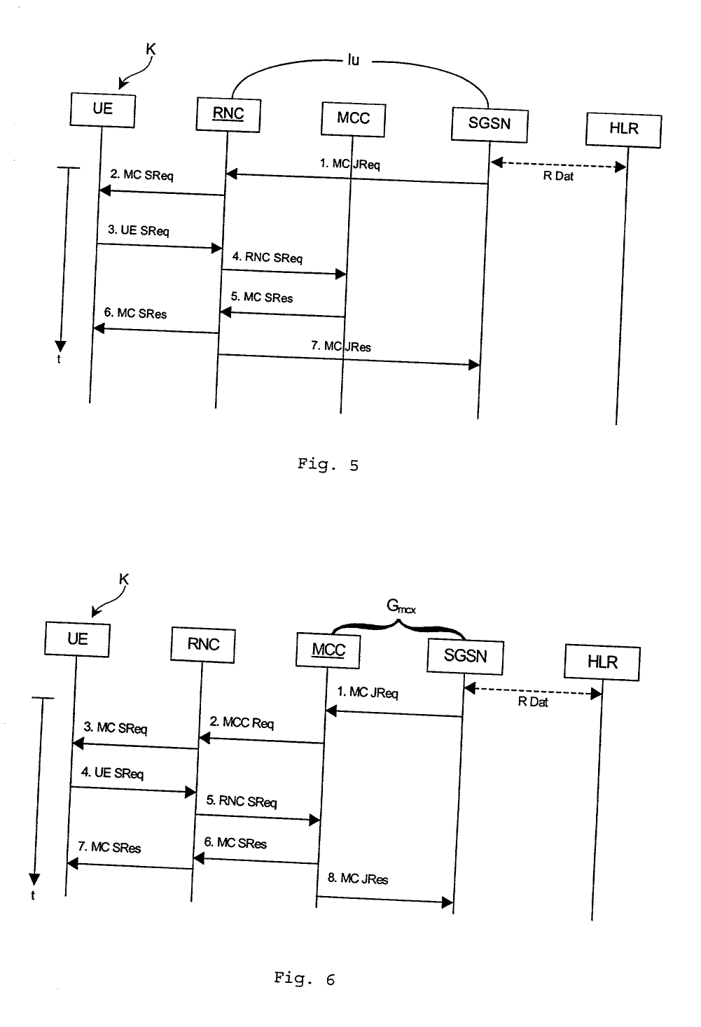

FIG. 6 shows a block diagram of one embodiment of the present invention, using a different interface within the system as shown in FIG. 3.

### DETAILED DESCRIPTION OF THE INVENTION

The illustration in FIG. 1 is a simplified block diagram which shows one implementation of a known structure for information transmission. In a communication system S, a message M is sent from a system operator OP, as the provider, to subscribers K who are in the form of users and registered customers for various services within the system S. The message M has advertising content which contributes to the financing of the communication system S and thus, also reduces the costs to the subscribers K by a certain amount. Since the message M is, in each case, transmitted individually by the operator OP to the subscribers K, this method requires a wide bandwidth and leads to a high load on the operator OP. A structure as shown in FIG. 1 is also implemented in mobile radio networks from various operators or providers OP, in which it is possible for the subscriber to be sent information and messages on various subjects to his/her mobile radio. For example, it is possible for him/her to be sent the current stock market rates, weather messages, lottery numbers, etc. However, on the basis of a structure as shown in FIG. 1, this service can be offered only in a manner which conserves resources very poorly.

A mobile radio subscriber who wishes to use such a service for this purpose registers with an appropriate cell broadcast CB group. He/she does this by making appropriate settings on his/her mobile radio. If the subscriber's mobile radio is now in the geographical region defined by the operator for a specific CB message and the subscriber is registered with the appropriate CB group, then he/she will read the appropriate messages whenever they are transmitted. If the subscriber no longer wishes to receive the messages, then he/she can make appropriate settings on his/her mobile radio at any time, and the messages will from then on no longer be read by the mobile radio.

A similar application is also feasible for transmitting information on the Internet via multicast MC. The messages on specific subjects are then no longer distributed as in the case of the broadcast BC within a geographical region, but are distributed to a defined group of subscribers who have previously registered to form a corresponding group.

One possible way to reduce the required bandwidth is to form the receivers into a group by using a multicast transmission MC, as is shown in the illustration in FIG. 2. The group association is, in this case, designed, according to the present invention, as a necessary condition for subscription within the communication system S and, as such, is also included in the calculation of a usage charge for each subscriber K. In this case, the various subscribers to whom the same message is intended to be transmitted are combined to form a group G as an interest group or multicast group, and this group is allocated an address, the multicast address. The data to be transmitted is then transmitted only once to this address. New accesses into existing groups do not result in any additional effort for the OP. The MC message is, in the ideal case, sent only once via shared connecting routes from the transmitter to the receivers. The operator OP, as the transmitter, need not know where and how many receivers are concealed behind the multicast address.

Since the operator's load is now considerably less than that in the situation in FIG. 1, the operator OP can now send a number of information items to different multicast groups G, and can, in each case, also receive acknowledgements F from them, in one development, which is only indicated here. The contents of such acknowledgements F are, inter alia, data on the use or utilization level of the respective group G.

In another method, a broadcast method BC, messages M are sent to all the subscribers K within a geographical region, that is to say by creating regional boundaries; for example, at a cellular level in a mobile radio system. Structurally, there are no significant differences between MC and BC, so that BC can also be illustrated on the basis of the diagram in FIG. 2. A region such as this may be, for example, defined by a part of the overall network. Information can be transmitted by broadcast to the mobile radio subscribers by the network operator initiating the entry into a broadcast group, rather than into a multicast group, as described above. One particularly advantageous feature in this case is that messages are then transmitted by broadcast to a group of mobile radio subscribers within a defined geographical region.

One application of this method is to transmit specific advertising for a company in whose vicinity a mobile radio subscriber is currently located. Appropriate messages could also then indicate to the mobile radio subscriber the route to the advertising company.

As in the case of multicast MC, a broadcast message in this case is also sent via shared connecting routes from the transmitter OP to a respective receiver K only once, in the ideal case. If he/she wants to receive BC messages, for example in the form of broadcast packets, each subscriber K must register in the appropriate broadcast group G. He/she can then determine whether he/she would like to receive or reject all the broadcast messages, or whether he/she would like to receive only certain messages. In one embodiment, the charge is established by a respective usage duration and also by the number of group registrations, thus acknowledging readiness to receive information from a number of different groups.

A subscriber decides to set up a new mobile radio contract. According to the present invention, he/she can now make a selection from various contract conditions. Various comparative examples are shown below:

1. Standard conditions, such as those which are normal with the present-day prior art:

| | | |
|---|---|---|
| monthly basic price: | DM | 30.00 |
| price per minute 0800-1800 | DM | 0.69 |
| (in the German landline network) | | |
| price per minute 1800-0800 | DM | 0.29 |
| (in the German landline network) | | |

2. Subsidized contract conditions according to one of the above embodiments:

| | | |
|---|---|---|
| monthly basic price: | DM | 10.00 |
| price per minute 0800-1800 | DM | 0.49 |
| (in the German landline network) | | |
| price per minute 1800-0800 | DM | 0.09 |
| (in the German landline network) | | |

The mobile radio subscriber (customer) accepts that, during use of his/her mobile radio, advertising, price and product information will be displayed on his/her monitor or display

The subscriber is aware that, during acoustic transmissions (telephony), these transmissions will be interrupted for a certain time period, in which advertising, etc., will then be transmitted. On average, these transmissions will amount to not less than 5 seconds and not more than 10 seconds per minute.

A mobile radio subscriber is also provided with the capability to change the contract form after specific time periods, if the chosen contract form is found to be unsuitable.

One particularly preferred application of the present invention is to set up a packet switched domain in a UMTS (Universal Mobile Telecommunication System) mobile radio system as shown in simplified form in the illustration in FIG. 3. A general subscriber terminal UE is, in this case, in the form of a mobile station MS, and is connected via an air interface Uu to a base station Node B. A Node B is connected via an interface Iub as a landline network connection to a radio network controller RNC, which controls and distributes the resources of the air interface Uu. One RNC may supply one or more nodes of the Node B type. The system, including a RNC and the corresponding Node Bs is referred to as a radio network subsystem RNS.

For packet-switching transmission, such as for transmission of IP packets from the Internet or an Intranet to a UE, a RNC is connected via an interface Iu as a landline network connection to an SGSN, Serving GPRS Support Node, where GPRS is an abbreviation for General Packet Radio Service. In order to transmit data from an external packet data network, such as the Internet, the SGSN is connected via an interface Gn as a landline network connection to the gateway GPRS support node GGSN. This GGSN provides the gateway or access point to an external packet data network. The GGSN is connected to a server in the Internet or Intranet via an interface Gi as a landline network connection.

Information for the management of the mobile subscribers can be checked by the GGSN via an interface Gc as a landline network connection, and by the SGSN via an interface Gr as a further landline network connection from a home location register HLR. The HLR is a databank which is responsible for the management of the mobile subscribers for one operator. Furthermore, the SGSN is responsible for setting up connections between a user and an external packet data network. If it is intended to transmit packet data from an external packet data network, then such packet data is first of all passed to the GGSN, which asks the HLR for the responsible SGSN. This GGSN now reports to SGSN that data is waiting for the appropriate UE. The SGSN causes connections to be set up between the UE and the external network. In the illustration shown in FIG. 3, these connections are shown as monitoring or control connections in the form of dashed lines.

A number of assumptions in an area of the UMTS which has not yet been standardized at the moment will now be made for the following exemplary embodiments with respect to the network elements and interfaces for supporting multicast functionality. It should be mentioned that this relates to only one possible implementation of multicast in a UTRAN:

A multicast center MCC is connected via the logic interface Iu_{mcc} to one or more RNCs. The MCC has various functional characteristics to support the multicast functionalities. For example, it may contain a databank which contains information such as the subscriber identities, the associated MC groups and the RNCs which supply the MC subscribers. Furthermore, the MCC initiates the setting up of connections to the appropriate RNCs, distributes the MC messages in the previously defined service regions taking account of the actual subscriber situation, and monitors those accessing and leaving MC groups.

A G_{mcx} interface connects the MCC and the SGSN as an interface. Information is transmitted via this interface as a call data record CDR in order to charge for the activities of the respective subscribers. This information is then transmitted from the SGSN to the charging gateway function CGF, which triggers all further processes relating to charging. Via the G_{mcx} interface, the MCC also can request subscriber information from SGSN, which then requests this information from the HLR. In addition, apart from control commands, data also can be transmitted via the interfaces G_{mcx} and Iu_{mcc}.

This embodiment of the present invention also defines possible information flows between a multicast center, a subscriber who has registered with an MC group and the SGSN, using which a user can be requested to enter a multicast group.

The various situations described below will be considered in order to analyze the information flow for forced registration in a multicast and/or broadcast group by the network operator OP. The following embodiments differ in the connections via which the appropriate messages are interchanged between the network elements, and in which network elements the monitoring function for registration is implemented. During the registration procedure (GRPS attach procedure, see 3GPP TS 23.060, General Packet Radio Service (GPRS), Service Description, Stage 2, Release 99, available, inter alia, in the Internet at www.3GPP.org) of a UE in the network, forced registration with a multicast group is, according to the present invention, initiated. In the embodiments described in the following text with reference to the illustration in FIG. 3, the network element G, as shown in FIG. 2, includes the network section from the GGSN as far as and including the node Bs at the cellular level. Corresponding to the profile of a subscriber who has registered with a MC group, the SGSN knows, for example from the HLR, which multicast group a specific subscriber must enter, and forces membership of a respective group.

The individual information items which are interchanged between the network elements using the interface Iu between the MCC and SGSN are shown, plotted in sequence against the time t, in the illustration in FIG. 4, with the multicast center MCC in this case being used as the central monitoring network element:

1. The SGSN sends a request message to join a multicast group MC JReq, with the subscriber ID and the multicast group, to the RNC. According to the present invention, the latter contains the identity of the user as a subscriber ID and the identity of the multicast group MC which the relevant user K has to enter as a subscriber to be registered with an MC group, on the basis of his/her contract.

2. The RNC then sends a subscription request MC SReq, with the subscriber ID and the multicast group, to the MCC.

3. According to the present invention, the MCC sends an MC subscription request MMC Req, with the subscriber ID and the multicast group as well as a parameter sequence QoS to indicate the quality of service, and to the RNC.

4. The RNC sends its own request for MC subscription, RNC Req, with the subscriber ID and the multicast group, to the UE.

5. If the UE agrees to the proposed configuration, it sends a subscription request UE SReq, with the subscriber ID and the multicast group, to the RNC.

6. The RNC sends a subscription request RNC SReq, with the subscriber ID and the multicast group, to the MCC.

7. The MCC sends a subscription response MC SRes, with the subscriber ID and the multicast group, to the RNC.

8. The RNC passes the message MC SRes to the UE.

9. The RNC confirms to the SGSN the successful subscription of the subscriber, by sending to it a joint response MC JRes with the subscriber ID and the multicast group ID.

This completes the setting up of a connection.

In a further embodiment of the present invention, the RNC is used as a central monitoring network element, using the interface Iu between the MCC and the SGSN. The individual information items which are, in this case, interchanged between the network elements are shown chronologically in the illustration in FIG. 5, with the designations for messages with approximately the same content as in FIG. 4 being largely retained:

1. The SGSN sends a MC JReq message with the subscriber ID and the multicast group to the RNC.

2. The RNC sends a MC SReq request message with the subscriber ID and the multicast group to the UE.

3. If the UE agrees the proposed configuration, it sends a UE SReq message with the subscriber ID and the multicast group to the RNC.

4. The RNC sends a RNC SReq request with the subscriber ID and the multicast group to the MCC.

5. The MCC stores the subscriber K as a new member of the indicated multicast group, and sends a MC SRes as a subscription confirmation with the subscriber ID and the multicast group to the RNC.

6. The RNC passes the subscription confirmation MC SRes to the UE.

7. The RNC confirms to the SGSN the successful subscription of the subscriber by sending to it a MC JRes message with the subscriber ID and the multicast group ID.

Finally, the use of the G_{mcx} interface between the MCC and SGSN also will be considered, with the MCC forming the central monitoring network element. As in the previous exemplary embodiments as well, the HLR can transmit the information relating to a respective subscriber to the SGSN in advance, as indicated by dashed lines. The individual information items which are interchanged between the network elements in this case are once again shown chronologically in the illustration in FIG. 6:

1. The SGSN sends a MC JReq with the subscriber ID and the RNC ID as well as the multicast group to the MCC.

2. The MCC sends a request message MCC Req with the subscriber ID and the multicast group to the RNC.

3. The RNC then sends a request message MC SReq with the subscriber ID and the multicast group to the UE.

4. If the UE agrees to the proposed configuration, it sends a UE SReq message with the subscriber ID and the multicast group to the RNC.

5. After receiving the UE SReq message, the RNC sends a RNC SReq message with the subscriber ID and the multicast group identification and/or multicast group ID to the MCC.

6. The MCC confirms the successful subscription of the subscriber K and sends a MC SRes with the subscriber ID and the multicast group ID to the RNC.

7. The RNC passes the MC SRes message to the UE.

8. The MCC finally confirms to the SGSN the successful registration via a MC JRes message with the subscriber ID and the multicast group ID.

In any of the situations mentioned above, the network can, according to the present invention, refuse to register the user or UE in the network if a UE does not agree to join the multicast group. Refusal to join a multicast group may occur, in particular, if the UE does not agree to the proposed configuration in the “Request MC subscription message.”

Furthermore, a transmission of information as described above also can be transmitted via point-to-point links to the appropriate mobile radio subscribers via individual connections. Rather than initiating entry into a multicast or broadcast group as described above, the network operator then initiates entry, in an entirely general form, into a specific group XY which is intended to be supplied with information of the type mentioned above.

The reduction in the required bandwidth for channels between a provider OP and a large number of subscribers K means that a system according to the present invention can be matched to Standards for various communication systems using a method described above. Although use in a UMTS system with various adaptation variants has been described in great detail, advantageous use in other applications is not precluded.

Although the present invention has been described with reference to specific embodiments, those of skill in the art will recognize that changes may be made thereto without departing from the spirit and scope of the present invention as set forth in the hereafter appended claims.

1. A method for transmitting information in electronic form from a provider to a registered user in a communication system, the method comprising the steps of:
allocating the user to at least one group of users as at least one of an access precondition and a usage precondition for the communications system; and
transmitting the information to all users in the at least one group.

2. A method for transmitting information as claimed in claim 1, the method further comprising the step of combining users in a target group to form the at least one group.

3. A method for transmitting information as claimed in claim 1, the method further comprising the step of allocating to the at least one group a broadcast address.

4. A method for transmitting information as claimed in claim 1, the method further comprising the step of accessing the user via a mobile station as an interface to the communication system.

5. A method for transmitting information as claimed in claim 1, wherein the information is transmitted via the communication system to a mobile station, in the form of a mobile telephone, using a known mobile radio standard.

6. A method for transmitting information as claimed in claim 1, wherein the information is transmitted by the provider to the user in accordance with a UMTS standard, at least in places.

7. A method for transmitting information as claimed in claim 1, the method further comprising the step of forming the at least one group by creating regional boundaries.

8. A method for transmitting information as claimed in claim 1, the method further comprising the step of initiating the transmission of the information by registration of the user in the communication system by switching on a subscriber terminal.

9. A method for transmitting information as claimed in claim 1, the method further comprising the steps of:
evaluating at least one of usage data and other data relating to the user; and
automatically allocating the user, based on the evaluation, to the at least one group.

10. A method for transmitting information as claimed in claim 1, the method further comprising the step of establishing a usage payment for the user as a function of at least one of a nature and a number of groups.

11. An apparatus for transmitting information in electronic form from a provider to a registered user in a communication system, comprising a device connected to one of the provider and an operator of the communication system for transmitting the information, wherein each user is entered in the device and the device transmits the information to all subscribers who are known in the device.

12. An apparatus for transmitting information as claimed in claim 11, wherein a plurality of devices are provided which are respectively connected via one channel with a specific address to one of the provider and the operator of the communication system in order to transmit the information.

13. An apparatus for transmitting information as claimed in claim 11, wherein the device at least one of memorizes and sends back an acknowledgment to one of the provider and the operator of the communication system.

14. An apparatus for transmitting information as claimed in claim 11, wherein a mobile radio connection is provided, at least in places, as a channel for transmitting the information.

15. An apparatus for transmitting information as claimed in claim 11, further comprising a mobile subscriber terminal for at least one of a mobile telephone and a portable telephone using a UMTS standard.

16. An apparatus for transmitting information as claimed in claim 15, wherein a serving GRPS support node is provided within the communication network for checking a user profile with at least one entry for a group from a data bank.

17. An apparatus for transmitting information as claimed in claim 16, wherein the data bank is a home location register.

18. A communication system for interchanging data, in which each user is registered with one of a provider and a network operator, the system comprising:
a provider;
a registered user; and
an apparatus for transmitting information in electronic form from the provider to the registered user, wherein the apparatus includes a device connected to the provider for transmitting the information, with each user being entered in the device, and the device transmits the information to all subscribers who are known in the device.

19. A communication system for interchanging data as claimed in claim 18, wherein the device is a mobile unit.

20. A communication system for interchanging data as claimed in claim 18, wherein the device is one of a mobile telephone and a mobile data transmission device using a UMTS standard.
